(19) United States
(12) Patent Application Publication
(10) Pub. No.: US 2011/0131033 A1
(43) Pub. Date: Jun. 2, 2011

(54) Weight-Ordered Enumeration of Referents and Cutting Off Lengthy Enumerations

(75) Inventor: Tatu J. Ylonen, Espoo (FI)

(73) Assignee: TATU YLONEN OY LTD, Espoo (FI)

(21) Appl. No.: 12/629,606

(22) Filed: Dec. 2, 2009

(51) Int. Cl. G06F 17/27

(52) U.S. Cl. 704/9

(57) ABSTRACT

In many reference resolution problems there are many candidate referents, and the overhead of enumerating them can be considerable. The overhead is reduced by stopping enumeration before all candidate referents have been enumerated, utilizing the properties of ordered and semi-ordered enumerators. Converting semi-ordered enumerators into ordered enumerators and combining several ordered enumerators into a single using dynamic weightings for handling determiner interpretations are disclosed.

### CROSS-REFERENCE TO RELATED APPLICATIONS

Not applicable

### INCORPORATION-BY-REFERENCE OF MATERIAL SUBMITTED ON ATTACHED MEDIA

Not applicable

### TECHNICAL FIELD

The present invention relates to computational linguistics, particularly to reference resolution and disambiguation in automatic interpretation of natural language.

### BACKGROUND OF THE INVENTION

Despite decades of study in automatic natural language interpretation, computational reference resolution is still largely limited to co-reference resolution. The shortcomings of current systems and challenges for future systems are discussed in M. McShane: Reference Resolution Challenges for an Intelligent Agent The Need for Knowledge, draft accepted for future publication in IEEE Intelligent Systems, 2009 (DOI 10.1109/MIS.2009.85, printed Nov. 9, 2009).

A conventional architecture for reference resolution is presented in D. Cristea et al: Discourse Structure and Co-Reference: An Empirical Study, Proceedings of the Workshop The Relation of Discourse/Dialogue Structure and Reference, pp. 46-53, Association for Computational Linguistics (ACL), 1999. Their approach is a pipelined architecture with three modules: a COLLECT module determines a list of potential antecedents for each anaphor; a FILTER module eliminates referents incompatible with the anaphor; and a PREFERENCE module determines the most likely antecedent on the basis of an ordering policy.

Conventional pronominal anaphora resolution is described in S. Lappin et al: An algorithm for pronominal anaphora resolution, Computational Linguistics, 20(4):535-561, 1994.

Conventional approaches are further detailed in M. Kameyama: Recognizing referential links: An information extraction perspective, pp. 46-53 in Proc. ACL/EACL'97 Workshop on Operational Factors in Practical, Robust Anaphora Resolution, Association for Computational Linguistics (ACL), 1997.

A system using weights that are adjusted at multiple stages of the natural language processing pipeline is presented in D. Carter: Control Issues in Anaphor Resolution, Journal of Semantics, 7:435-454, 1990.

The above mentioned references are hereby incorporated herein by reference.

Broadly speaking, the conventional systems enumerate candidate referents, filter them using various criteria, evaluate a weight for the candidates, and select one or more candidates with the highest weight.

As noted by McShane, rather little work has been done on reference resolution other than co-reference resolution. It is quite common to refer to entities or concepts in the discourse participants' shared knowledge or in generally known knowledge in a particular culture. Another important, largely unsolved problem in reference resolution is finding referents that have not been directly mentioned in the discourse, but that are associated with a previously mentioned object. For example, in “Tom arrived at the station, and went to the counter”, we immediately understand what “the counter” means; however, it need not have been previously mentioned in the discourse, as we know that [train] stations typically have a ticket counter.

A big architectural problem with the conventional approaches is that the set of referents in shared or generally known knowledge can be quite large, and particularly for inferred referents, extremely large. It may then become prohibitively expensive to collect a list of potential antecedents or referents, which is a key element of the conventional reference resolution architecture.

### BRIEF SUMMARY OF THE INVENTION

An improved reference resolution architecture is disclosed, wherein preference computation and optionally filtering are moved into the enumerator, and early termination of enumeration is facilitated by generating weighted candidate referents in descending order of weight, and cutting off enumeration after a desired number of sufficiently good candidates have been enumerated.

It is also disclosed how to construct enumerators for various referent sources in such a way that descending order of returned weights is guaranteed, even if the original enumerator only provides a descending upper limit for the weight of later returned candidates.

The new architecture provides major benefits in situations where many potential referents exist, such as when processing references to shared or general knowledge, and inferred referents. It is anticipated that the disclosed improvement will be important in building robust domain-independent natural language processing systems for applications such as machine translation, semantic search systems, information extraction, spam filtering, computerized assistance applications, computer-aided education, voice-interactive games, and natural language controlled robots.

While the need for resolving shared, generally known, and inferred referents efficiently has been known and discussed for decades in the linguistics literature, but has remained largely unsolved.

A first aspect of the invention is a method comprising:
enumerating, by a computer, a first plurality of candidate referents for a referring expression in a natural language expression in semi-descending order of weight using a first enumeration source; and
cutting off, by the computer, the enumeration before all available candidates have been enumerated in response to set criteria for previously enumerated candidates having been met.

A second aspect of the invention is an apparatus comprising:
a natural language interface comprising a reference resolver;
a first semi-ordered enumerator coupled to the reference resolver; and
a cutoff logic coupled to the enumerator for terminating enumeration before all available candidates have been enumerated in response to set criteria for previously enumerated candidates having been met.

A third aspect of the invention is a computer comprising:
a means for resolving references in a natural language expression;
a means, coupled to the means for resolving references, for enumerating candidates for a referring expression in a natural language expression in descending order of weight;
a means, coupled to the means for enumerating, for cutting off the enumeration before all available candidates have been enumerated in response to set criteria for previously enumerated candidates having been met.

A fourth aspect of the invention is a computer program product stored on a tangible computer-readable medium, operable to cause a computer to resolve references for a referring expression in a natural language expression, the product comprising:
a computer readable program code means for enumerating a first plurality of weighted candidate referents for the referring expression in semi-descending order; and
a computer readable program code means for cutting off the enumeration before all available candidates have been enumerated in response to set criteria for previously enumerated candidates having been met.

This summary is provided to introduce a selection of concepts in a simplified form that are further described below in the detailed description. This summary is not intended to identify key features or essential features of the claimed subject matter, nor is it intended that this summary be used to limit the scope of the claimed subject matter. Furthermore, the claimed subject matter is not limited to implementations that solve any or all disadvantages noted in any part of this disclosure.

### BRIEF DESCRIPTION OF THE SEVERAL VIEWS OF THE DRAWING(S)

Various embodiments of the invention are illustrated in the drawings.

FIG. 1 illustrates a computer where a reference resolver uses an ordered enumerator and cutoff logic.

FIG. 2A illustrates a robot embodiment of the invention.

FIG. 2B illustrates an appliance embodiment of the invention.

FIG. 3 illustrates reference resolution using an ordered enumerator and cutting off length enumerations.

FIG. 4 illustrates constructing an ordered enumerator from a semi-ordered enumerator.

FIG. 5 illustrates direct implementation of an ordered discourse referent enumerator.

FIG. 6 illustrates combining more than one enumerator into a single ordered enumerator with dynamic weight adjusting.

### DETAILED DESCRIPTION OF THE INVENTION

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, an apparatus, or a computer program product which is an aspect of the invention may comprise any number of the embodiments or elements of the invention described in this specification.

Separate references to “an embodiment”, “one embodiment”, or “another embodiment” refer to particular embodiments or classes of embodiments (possibly different embodiments in each case), not necessarily all possible embodiments of the invention. Unless otherwise mentioned, “or” means either or both, or in a list, one or more of the listed items.

### Definitions of Some Terms Used in the Specification

In this specification, the referent of a referring expression means a concept, entity, object, set, person, message, text passage, document, act, manner, place, time, reason, or some other meaning referenced by the referring expression.

Referring expressions can be, without limitation, e.g., morphemes (“Euro-”), pronouns (“she”), names (“John Smith”, “Bush the elder”, “your friend Mike”), definite noun phrases (“the house”), verbs (“partying”), adverbs (“there”), adjectives (“such”), or clauses (“When we were in Greece, . . . ”). In some embodiments a referring expression can be understood very broadly, even considering the normal word meaning to be a kind of reference to a semantic concept. A referring expression may also comprise descriptive components that are not used in selecting the referent, and (in some languages) may also be discontinuous.

Referring expressions that are noun phrases need not necessarily have a definite article. For example, “a certain high government official” might perfectly well be understood to refer to a specific person in a particular situation. Also, it is possible to consider something like “a beach house in the Bahamas” a referring expression; while it may not refer to a particular house in the recipient's knowledge, it may certainly raise some images that are much more than the sum of the meanings of the words. In some embodiments indefinite phrases (even all of them) may be considered special kids of referring expressions whose possible referents (candidates) can be enumerated (some of the candidates could be created dynamically during enumeration).

Natural language means any language normally used by humans to communicate with each other (e.g., English, Chinese, Esperanto, ASL), or any other language with comparable expressive power, whether naturally evolved, designed, or otherwise created, and whether encoded using sounds, glyphs, points (as in Braille), gestures, electrical signals, or otherwise.

A natural language expression can mean any communication taking place in the natural language. Examples of natural language expressions include words (“yesterday”), phrases (“back home”), sentences (“I saw him kiss your wife—passionately!”), e-mails, documents, or other communications or parts thereof.

A candidate for the referent of a referring expression, or candidate referent, or candidate for short, means a possible choice for the referent. For some referring expressions, there may be very many candidate referents, particularly if the referring expression may refer to referents in shared or general knowledge, or may be an inferred referent somehow associated with the referring expression. There may be zero, one, or more candidate referents for any particular referring expression.

Enumerating candidates for a referring expression means listing candidate referents for the referring expression one at a time or several at a time. While for some referring expressions all candidates may be immediately available, for other referring expressions not all candidates are returned (given as the result of the enumeration) at once. When only some of the candidates have been returned, the enumeration can be continued until no more candidates are available. It is expected that in most embodiments enumerating will return one candidate at a time, but this is not a requirement.

An enumeration source refers to a specification of what candidates are to be enumerated and a means for enumerating according to the specification. In many embodiments, it corresponds to a particular kind of enumerator (e.g., indefinite enumerator, discourse enumerator, shared knowledge enumerator, general knowledge enumerator, inferring enumerator), where the enumerator (typically a program code means or a digital logic circuit) implicitly acts as the specification (usually with some parameters extracted from the referring expression). In some other embodiments, the enumeration source is specified by a dynamically configurable program in some suitable formalism (such as Prolog or logical inference formulas). The source may be selected based on the contents of the referring expression (e.g., its determiner, or its main word (head)), and may be parameterized by constraints from the referring expression. An enumeration source may also be a combination of two or more enumeration sources, where the individual sources might be selected based on, e.g., alternative determiner interpretations, and combining could be influenced by weights associated with such interpretations.

Candidates may be weighted, meaning that they have one or more weights associated with them. The weight is a measure of how “good” the candidate is, i.e., how likely it is to be the correct intended referent. In this specification it is assumed that higher numerical weights indicate better candidates (and “best candidate” means one with the highest weight, or one of those with the highest weight, if there are more than one with the same weight). It would be equivalent to represent better weights using smaller numeric values, mutatis mutandis. In some embodiments it may be advantageous to limit weights to the range 0 . . 1.0. The weight may represent a probability, plausibility, score, or other numeric “goodness” measure in various embodiments. Some embodiments, particularly those interpreting the weight as a probability, may impose additional constraints on the weights (such that the sum of the weights of the alternatives equal 1.0, which may sometimes require dividing the weights by their sum to meet this constraint).

A weight associated with a candidate (also called a weight of the candidate) may be the weight of the candidate itself, or it may refer to an upper limit on the weights of any future candidates returned by the same enumeration. In some embodiments only one of these is associated with a candidate; in others, both (and possibly others) are associated with a candidate. The candidate may be said to comprise these weights, and typically they would be stored in the data structure representing the candidate, but they could also be returned separately (e.g., the current upper limit might be retrievable separately from an enumerator object).

Semi-descending order on a sequence of values means either a non-monotonically (or more strongly) descending order or an order where the upper limit on the weights of any later values is smaller than or equal to the limit for previous values (and is strictly smaller for at least some value(s)). Semi-ordered means having semi-descending order or producing values in semi-descending order [of weights].

An ordered enumerator is an enumerator that returns candidates in non-monotonically (or more strongly) descending order. A semi-ordered enumerator is an enumerator that returns candidates in semi-descending order.

Non-monotonically descending means that each successive value is smaller than or equal to the previous one. An example of a more strongly descending order would be a monotonically descending order, where each successive value is smaller than the previous one. [Here, smaller means “less good”, and if smaller weight values were used to indicate better candidates, the meaning of descending would be reversed when applied to numerical weight values.]

Filtering candidates means applying some constraints from the referring expression to the candidates. Depending on the embodiment, filtering may, e.g., reject candidates that do not match the constraints (called absolute filtering), may adjust the weight of the candidates based on how well they match the constraints (called soft filtering), and/or may annotate the candidate with information indicating which constraints were matched, not matched, or had insufficient information available (called annotating filtering). Rejecting a candidate causes it not to be processed further. An absolute constraint is one that causes the candidate to be rejected if the constraint is not met.

A constraint from the referring expression means something in the referring expression that restricts or describes the referent. Constraints may be derived from, e.g., adjectives, relative clauses, prepositional phrases, or gender of a personal pronoun. Some constraints are restrictive, i.e., they restrict which candidates are possible referents of the referring expression. Some other constraints are descriptive, i.e., they provide additional information about the referent but are not necessarily used to restrict the possible referents. In some cases it is not possible to know a priori which constraints are restrictive and which are descriptive. In such cases it may be useful if filtering annotates the candidates with information about how the constraints were used, allowing the unused information to be learned as additional descriptive information.

In some cases descriptive information may actually have other functions than description, such as ironic, derogatory, affective, or manipulative. As an example, imagine the villain saying “you have a very pretty girl” to a father being extorted for information, threatening to hurt the girl. [Note also how we just introduced a new character with “the villain”, and referred to (in the imagined context) known person with “a girl”.]

Selecting means picking one of a number of alternatives, usually based on some specified criteria. If there is only one alternative, selecting may mean taking that alternative. In some embodiments, selecting may also return a special “no selection” indication, if no alternative matches specified criteria.

Cutting off enumeration means terminating the enumeration before all available candidates have been enumerated. Particularly for some kinds of enumeration sources there may be very many candidates available, and the enumeration could take very long if it wasn't cut off at some point.

### Apparatus Embodiment(s)

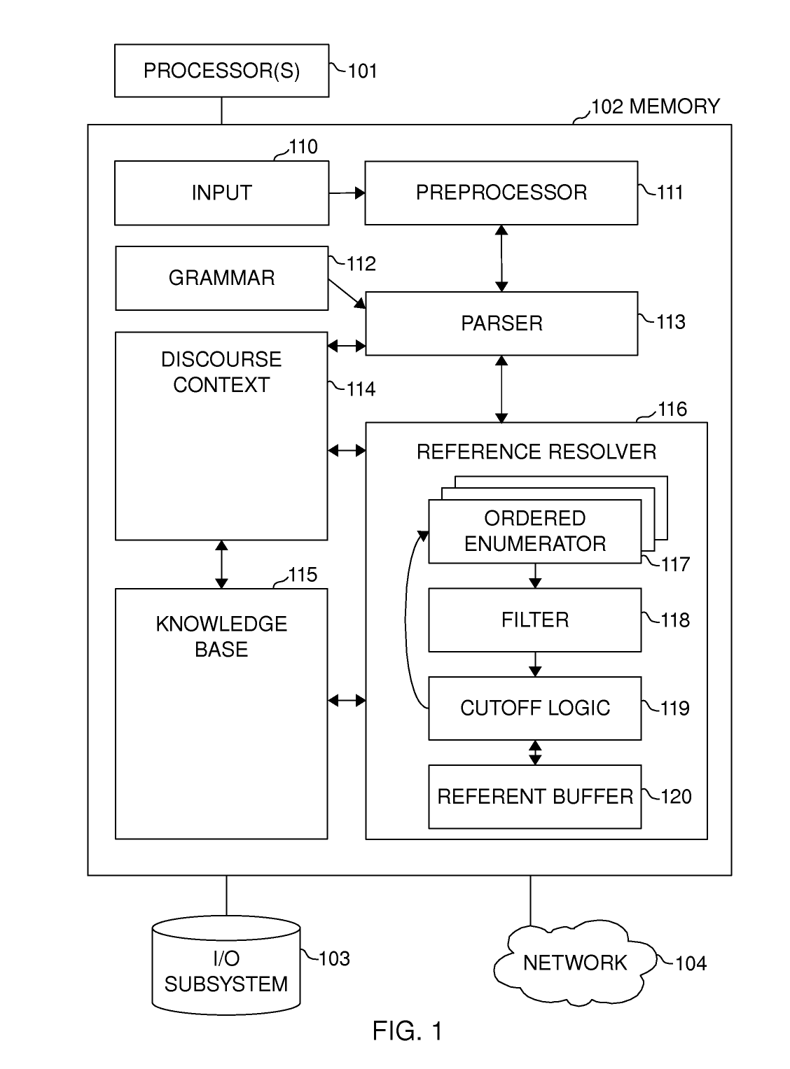

FIG. 1 illustrates an apparatus (a computer) according to a possible embodiment of the invention. (101) illustrates one or more processors. The processors may be general purpose processors, or they may be, e.g., special purpose chips or ASICs. Several of the other components may be integrated into the processor. (102) illustrates the main memory of the computer. (103) illustrates an I/O subsystem, typically comprising mass storage (such as magnetic, optical, or semiconductor disks, tapes or other storage systems, RAID subsystems, etc.; it frequently also comprises a display, keyboard, speaker, microphone, camera, manipulators, and/or other I/O devices). (104) illustrates a network interface; the network may be, e.g., a local area network, wide area network (such as the Internet), digital wireless network, or a cluster interconnect or backplane joining processor boards and racks within a clustered or multi-blade computer. The I/O subsystem and network interface may share the same physical bus or interface to interact with the processor(s) and memory, or may have one or more independent physical interfaces. Additional memory may be located behind and accessible through such interfaces, such as memory stored in various kinds of networked storage (e.g., USB tokens, iSCSI, NAS, file servers, web servers) or on other nodes in a distributed non-shared-memory computer.

An apparatus according to various embodiments of the invention may also comprise, e.g., a power supply (which may be, e.g., switching power supply, battery, fuel cell, photovoltaic cell, generator, or any other known power supply), sensors, circuit boards, cabling, electromechanical parts, casings, support structures, feet, wheels, rollers, or mounting brackets.

(110) illustrates an input to be processed using a natural language processing system. The original input may be a string, a text document, a scanned document image, digitized voice, or some other form of natural language input. More than one natural language expression may be present in the input, and several inputs may be obtained and processed using the same discourse context. The input may be received over a network (Internet, telephone network, mobile data network, etc.) using any suitable protocol (e.g., HTTP, SIP).

The input passes through a preprocessor (111), which may perform OCR (optical character recognition), speech recognition, tokenization, morphological analysis (e.g., as described in K. Koskenniemi: Two-Level Morphology: A General Computational Model for Word-Form Recognition and Production, Publications of the Department of General Linguistics, No. 11, University of Helsinki, 1983), morpheme graph or word graph construction, etc., as required by a particular embodiment. The grammar may configure the preprocessor (e.g., by morphological rules and morpheme inventory).

The grammar (112) may be a unification-based extended context-free grammar (see, e.g., T. Briscoe and J. Carroll: Generalized Probabilistic LR Parsing of Natural Language (Corpora) with Unification-Based Grammars, Computational Linguistics, 19(1):25-59, 1993), though other grammar formalisms can also be used. In some embodiments the original grammar may not be present on the computer, but instead data compiled from the grammar, such as a push-down automaton and/or unification actions, may be used in its place. In some embodiments the grammar may be at least partially automatically learned, and may be stored in the knowledge base.

(113) illustrates a parser capable of parsing according to the formalism used for the grammar. It may be an extended generalized LR parser (see, e.g., M. Tomita: Efficient Parsing for Natural Language: A Fast Algorithm for Practical Systems, Kluwer, 1986) with unification. The parser may produce parse trees (or a graph-structured parse forest), unification feature structures, or it may directly produce a suitable machine-readable description of a referring expression. Known parsing systems available on the market include, e.g., the Stanford Parser, the ERG system, and the Connexor Machinese platform. The parser may maintain a number of parse contexts representing different choices for certain ambiguous aspects of the input.

The discourse context (114) comprises information about the current discourse and previously parsed sentences (though some embodiments may keep several sentences in the parse context) as well as about the participants to the current discourse and about the current topic area. In a practical system there are likely to be many discourse contexts, and each input is processed in the context of some discourse using the associated discourse context. In many embodiments the discourse context is a data structure comprising a list or array of entities that have recently occurred in the discourse.

The knowledge base (115) provides background knowledge for the reference resolver (and may also be used by other components). It may comprise a lexicon, word meaning descriptions, selectional restriction information, thematic role information, grammar, statistical information (e.g., on co-occurrences), generally known information, shared information with various participants, common sense knowledge (such as information about the typical sequences of events in particular situations), etc.

Some disambiguation or reference resolution actions may perform logical inference over knowledge in the knowledge base. In some embodiments the knowledge base may reside partially in non-volatile storage (e.g., magnetic disk) or on other nodes in a distributed system.

Data may be represented in the knowledge base using any combination of different knowledge representation mechanisms, including but not limited to semantic networks, logical formulas, frames, text, images, spectral and temporal patterns, etc. In some embodiments the knowledge base may also comprise specifications for various enumeration sources.

Advantageous organizations for information in the knowledge base can be found from the books J. F. Sowa: Conceptual Structures Information Processing in Mind and Machine, Addison-Wesley, 1984; J. F. Sowa: Principles of Semantic Networks Explorations in the Representation of Knowledge, Morgan Kaufmann, 1991; G. Fauconnier: Mental Spaces: Aspects of Meaning Construction in Natural Language, Cambridge University Press, 1994; and H. Helbig: Knowledge Representation and the Semantics of Natural Language, Springer, 2006. Such information is best utilized using inference methods such as those described in the book R. Brachman et al: Knowledge Representation and Reasoning, Elsevier, 2004, which also contains an overview of various additional knowledge representation methods.

The reference resolver (116) determines the referent of a referring expression. Various ways of implementing a reference resolver (or more general disambiguator) are described in the co-owned U.S. patent application Ser. Nos. 12/622,272 and 12/622,589, which are hereby incorporated herein by reference. They describe a joint disambiguator and a multi-context disambiguator.

In some embodiments the reference resolver may return multiple candidate referents, leaving the final selection for later interpretation steps (or possibly as genuine ambiguity in the input).

The reference resolver comprises an ordered enumerator (117), a filter (118), a cutoff logic (119), and a referent buffer (120).

The ordered enumerator (117) enumerates candidates for a referring expression in non-monotonically descending order of weight. It may comprise several subcomponents (such as those described elsewhere herein), and may also comprise a semi-ordered enumerator and a reordering buffer, or several ordered or weakly ordered enumerator with dynamic weighter-selector. Implementation of non-ordered enumerators is described in the papers by Cristea et al (1999), Lappin et al (1994), and Kameyama (1997).

The filter (118) determines whether each potential candidate matches constraints imposed on the referent. The filter may be a separate module or step connected to the ordered enumerator for receiving candidates from it, or it may be integrated within the ordered enumerator, for example for filtering the candidates already before determining their weight or ordering them. The filter may also be implemented at least partially implicitly by an indexing mechanism (a database query mechanism) used by the ordered enumerator to find candidates. The filter typically uses, e.g., adjectives, relative clauses, prepositional phrases, and/or gender of a pronoun to restrict potential referents. The filter may perform, e.g., absolute and/or soft filtering. The above mentioned references disclose how to implement filtering.

The cutoff logic (119) causes the ordered enumerator to stop generating more candidates (or, in some embodiments, causes no more candidates to be requested from the ordered enumerator). It may, for example, compare the weight of the most recent candidate or the upper limit on the weight of any remaining candidates against a limit weight. The limit weight may be, e.g., the weight of the best candidate obtained so far minus a threshold, the weight of the worst candidate in the referent buffer (particularly when the referent buffer already holds the maximum number of candidates), or a value obtained from another component, such as a joint disambiguator or a multi-context disambiguator, as described in the referenced co-owned patent applications. In some embodiments the cutoff logic may be integrated within the ordered enumerator. For example, an ordered enumerator implemented as an object in an object-oriented programming environment (e.g., Java) could have a method for setting the minimum weight for any returned candidates.

The referent buffer (120) may hold one or more of the best candidates generated so far. It can be used to obtain a predetermined number of best candidates, or candidates whose weight is within a threshold of the best weight (the threshold could be absolute, i.e., a constant deducted from the best weight, or relative, i.e., a certain fraction of the best weight, the fraction usually represented by a number less than one). Not all embodiments necessarily have a referent buffer; instead, the reference resolver might use the candidates as they are generated.

An apparatus that is a computer according to an embodiment of the invention may operate, e.g., as a semantic search system (searcing Internet documents, company documents, legal documents, patent documents, scientific/technical literature, financial releases, etc.), computer-aided help system or on-line help system, information kiosk, portable translator, voice-controlled text processing system, call center, patent prior art or infringement analysis system, or an interactive game. Especially in Internet-oriented applications the computer is advantageously a clustered or distributed computer, possibly even a system of co-operating computers distributed to multiple locations but working together to provide a unified customer interface and access to essentially the same data.

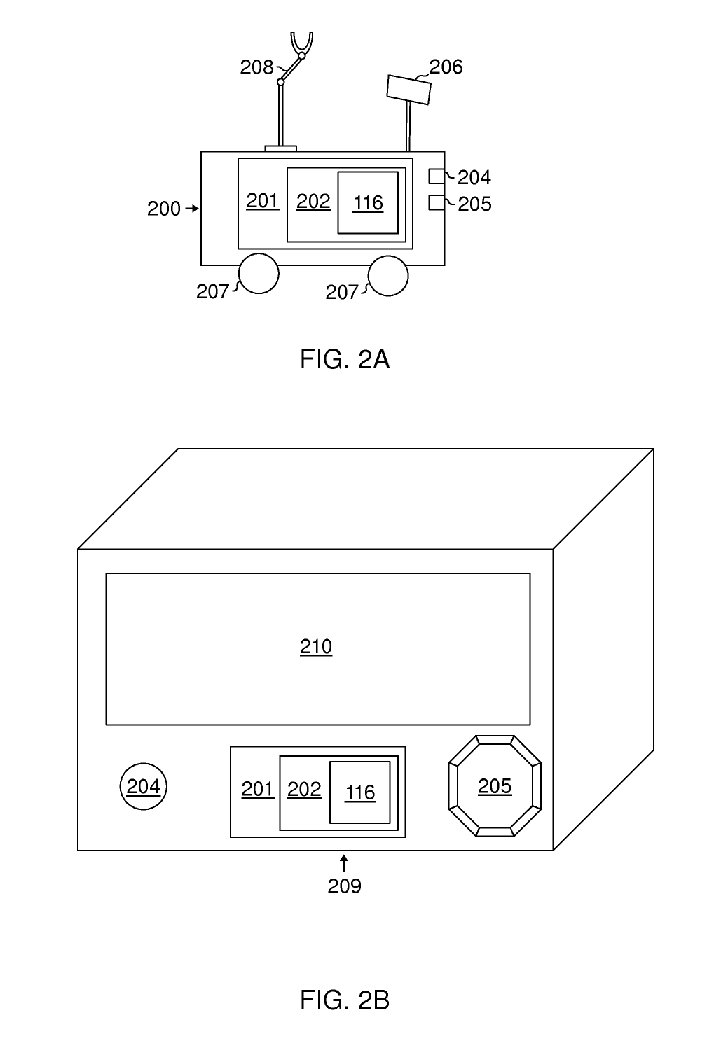

FIG. 2A illustrates a robot according to an embodiment of the invention. The robot (200) comprises a computer (201) for controlling the operation of the robot. The computer comprises a natural language interface module (202), which comprises a reference resolver (116) according to an embodiment of the invention. The natural language module is coupled to a microphone (204) and to a speaker (205) for communicating with a user. The robot also comprises a camera (206) coupled to the computer, and the computer is configured to analyze images from the camera at real time. The image processing module in the computer is configured to recognize certain gestures, such as a user pointing at an object (see, e.g., RATFG-RTS'01 (IEEE ICCV Workshop on Recognition, Analysis, and Tracking of Faces and Gestures in Real-Time Systems), IEEE, 2001 for information on how to analyze such gestures). Such gestures provide extralingual information that may be used in disambiguating the referent of certain natural language expressions (e.g., “take that bottle”). The robot also comprises a movement means, such as wheels (207) with associated motors and drives or legs, and one or more manipulators (208) for picking up and moving objects. The voice control interface makes the robot much easier for people to interact with, and multi-context disambiguation according to the present invention enables the voice control interface to understand a broader range of natural language expressions, providing improved user experience.

In some embodiments, the computer might be separate from the rest of the apparatus, communicating with the apparatus using, e.g., a radio network, but functionally being an important part of the apparatus (for example, it may be anticipated that some low-cost robots may have higher-level control offloaded to a personal computer in the house).

FIG. 2B illustrates a home or office appliance according to an embodiment of the invention. The appliance (209) comprises a computer (201) with a natural language interface (202) and a reference resolver (116) according to an embodiment of the invention. It also comprises a microphone (204) and speaker (205), and a display device (210) such as an LCD for displaying information to the user. As a home appliance, the appliance may be, e.g., a home entertainment system (often also comprising a TV receiver and/or recorder, video player (e.g., DVD or Blu-ray player), music player (e.g., CD or MP3 player), and an amplifier), or a game console (typically also comprising a high-performance graphics engine, virtual reality gear, controllers, camera, etc.), as they are known in the art. As an office appliance, it may, for example, provide information retrieval services, speech-to-text services, video conferencing or video telephony services, automated question answering services, access to accounting and other business control information, etc., comprising the additional components typically required for such functions, as are they known in the art. An improved natural language understanding capability due to the present invention could enable less skilled users to utilize such appliances. This could be commercially important especially in countries where many people are not comfortable with or trained for working with computers and/or typing, or for handicapped people.

The apparatus may also be a mobile appliance (including also portable, handheld, and wearable appliances). Such appliances differ from home and office appliances primarily in miniaturization and in other components known in the art. In such an appliance, significant parts of the voice control interface, including the reference resolver, could be implemented in digital logic to reduce power consumption, but could also be implemented in software. The present implementation may, for example, enable the construction of better portable translators than prior solutions.

An apparatus according to the invention could also be an ASIC, processor, or microchip for performing multi-context disambiguation, or a larger chip, processor, or co-processor for assisting in natural language processing functions generally.

Each kind of apparatus would also comprise other components typically included in such apparatus, as taught in US patents and technical literature.

### Reference Resolution Using an Ordered Enumerator

In conventional reference resolution all available candidates are enumerated from an enumeration source, and the candidates are then filtered and their preference order determined. According to the present invention, enumeration can be cut off before all candidates from an enumeration source have been enumerated. By constructing the enumerator in such a way that it enumerates the candidates in descending order of weight, or at least approximately descending order of weight, finding the best candidate can be guaranteed without enumerating all the candidates.

One embodiment of reference resolution using an ordered enumerator was illustrated in FIG. 1. An ordered enumerator (117) produces weighted candidates in non-monotonically descending order of weight. The filter (118) eliminates those candidates that do not match constraints derived from the referring expression, or adjusts their weights according to how well they match the constraints. The cutoff logic (119) decides when to stop enumerating more candidates, as described above. The referent buffer (120) optionally buffers the best candidate(s). In another embodiment the ordered enumerator is used as part of a joint disambiguator, where the cutoff logic may implemented as an optimization as part of joint enumeration (in which case the same cutoff logic may be shared by multiple ordered enumerators).

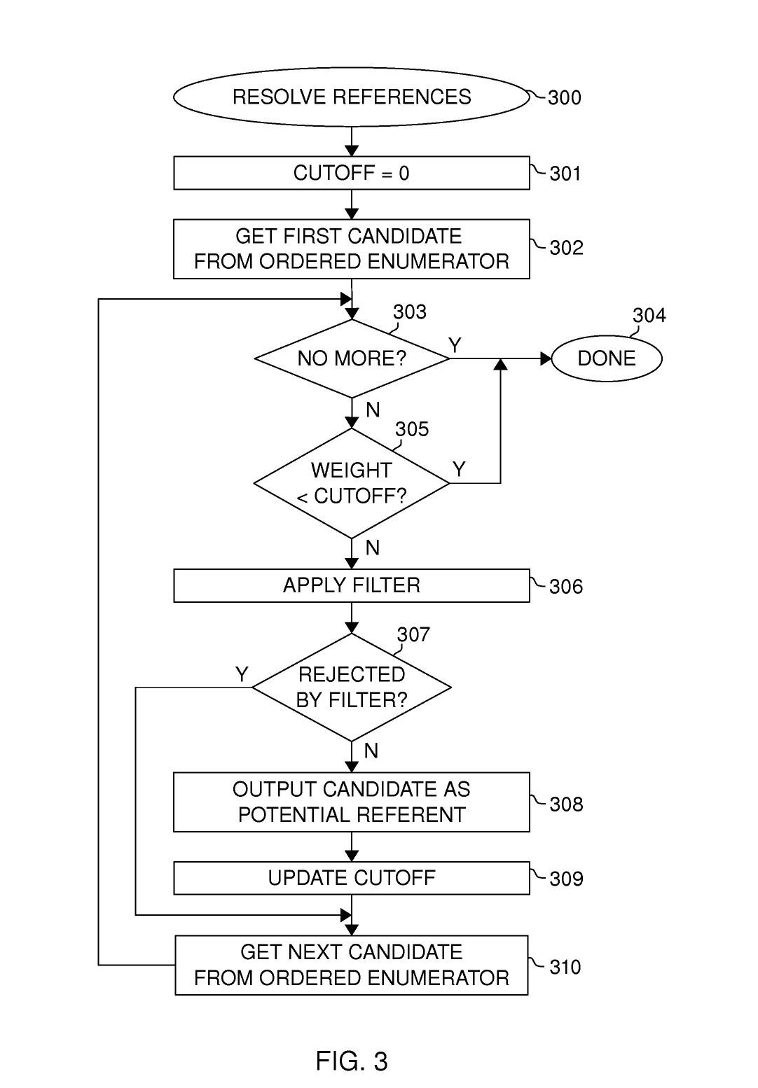

FIG. 3 illustrates performing reference resolution using an ordered enumerator according to an embodiment of the invention. (300) illustrates starting reference resolution for a referring expression in some particular context. (301) resets the cutoff to zero (assuming weights are in the range 0 . . 1.0, higher better). (302) gets the first candidate (if any) from the ordered enumerator.

(303) checks if a candidate was available. If there were no more candidates, reference resolution terminates at (304).

(305) checks if the weight of the candidate is below the current cutoff value. If so, enumeration is terminated by transitioning to (304). Since the ordered enumerator returns candidates in descending order of weight, no later candidate can become higher than the cutoff (assuming the cutoff does not decrease).

(306) applies filter to the candidate. The filter may update the candidate's weight (only downwards in the preferred embodiments). It may also reject the candidate, which is checked at (307). If the filter may adjust weights, then a reordering buffer (described below) may be used for converting what is now essentially a semi-ordered enumerator (with upper limit being the last weight reported by the ordered enumerator) back into an ordered enumerator for outputting the candidates in descending order by weight.

If the candidate was not rejected, it is output as a potential referent of the referring expression at (308). At (309), the cutoff value is updated, if appropriate. One possible update strategy is to track the best weight of any candidate output so far, and have the cutoff be the best weight multiplied by a constant (less than one, e.g., 0.1). In many embodiments the cutoff is only updated when the first candidate accepted by filtering is processed.

At (310), the next candidate (if any) is obtained from the ordered enumerator, and execution continues from (303).

In some embodiments reference resolution may comprise a separate planning step, at which time it is decided which enumerators to use, and how to combine them (e.g., using the combining and conversion means described herein).

An embodiment is also illustrated by the following pseudo-code (‘enum’ is ordered enumeration source providing an upper limit for the weight of further candidates, ‘filter constraints’ is a data structure comprising all the constraints based on which candidates are filtered, ‘CUTOFF FACTOR’ is a constant specifying how much worse acceptable candidates can be):

double cutoff = 0, best_weight = 0;
for (Candidate cand = enum.get_first_cand( ); cand;

cand = enum.get_next_cand( ))

{

double weight = cand.weight();
if (weight < cutoff)

break;

if (filter(cand, filter_constraints))

continue;

if (weight > best_weight)

{

best_weight = weight;
cutoff = CUTOFF_FACTOR * best_weight;

}

output(cand);

}

Cutting off enumeration is based on set criteria. Examples of possible criteria include: the number of candidates already returned; the weight of any remaining candidates known to be such that any further candidates cannot become within a threshold of the best already returned candidate; and the maximum number of candidates already having been buffered, and it being known that any further candidates cannot be better than the worst (lowest-weight, in the preferred embodiment) candidate in the buffer. That the weight of any further candidates cannot exceed a limit can generally be known from the weight of the most recent candidate having been below that limit (for ordered enumerator), or the upper limit being below that limit (for semi-ordered enumerator).

### Converting a Non-ordered or Semi-ordered Enumerator to an Ordered Enumerator

A non-ordered enumerator can be converted to an ordered enumerator in a number of ways. The simplest way is to just assign weights (preferences) to the candidates (such preference assignment is known in the art; see the mentioned references), and sort them into descending order by weight. This is practical for enumerators that are known to never return very many candidates.

An enumerator will be called semi-ordered if it returns candidates in semi-descending order. In other words, even though it might not generate candidates in (non-monotonically) descending order, it has a non-monotonically descending upper limit on the weight of any future candidates. Many, perhaps all, of the enumerator types that are needed in natural language understanding that can generate very many candidates can be constructed in this manner.

For example, when enumerating candidates from the discourse context, one of the important factors in determining saliency is how far back the reference is. That distance is thus one element in computing weight. If a non-monotonically descending distance metric is multiplied into the weight, and other factors are in the range 0.1, then the distance metric forms an upper bound for any further candidates.

As another example, when enumerating candidates for inferred references (for example, “the counter” at a train station), the inference may proceed from the main concept (here, “the counter”) using inference rules or links of varying weights (the weight relating to the strength of the association). If the links are traversed in descending order of weight during the inference, their weights (as well as other factors contributing to the weight of the candidate) are limited to the range 0 . . 1.0, and the values are multiplied together, the weight of the link currently being tried forms the upper limit. For inferences traversing long chains of links, a best-first (or shortest path) search strategy can be used. A multiplicative distance metric, with longer distances represented by lower values and all link traversals (or rule applications) causing the distance to be multiplied by a value in the 0 . . 1.0 range, allows the distance of the best candidate to be used as the upper limit.

Sometimes it is possible to construct an ordered enumerator directly. However, more often only an upper limit is conveniently available, resulting in candidates being returned in semi-descending order of weight.

A method of converting a semi-ordered enumerator into an ordered enumerator is thus needed, and could be highly beneficial for robust reference resolution for unrestricted text.

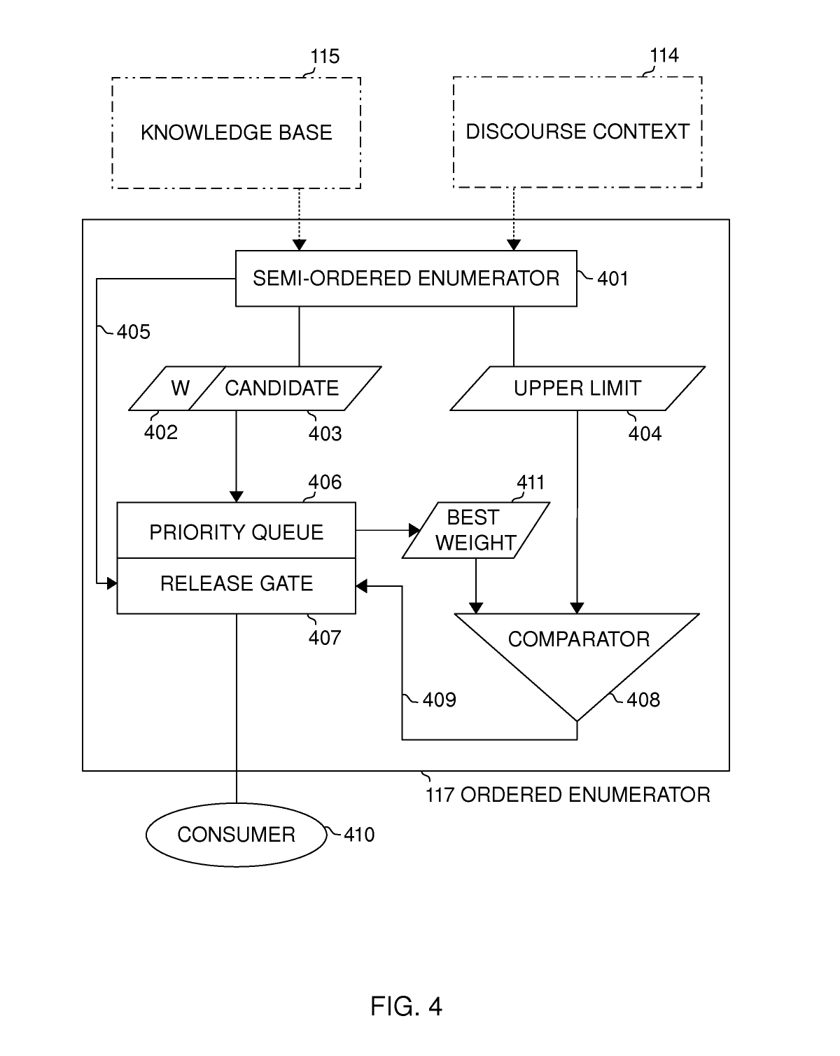

FIG. 4 illustrates one possible embodiment of constructing an ordered enumerator from a semi-ordered enumerator. (117) is the constructed ordered enumerator. (401) illustrates the semi-ordered enumerator; it may use information from, e.g., the knowledge base (115) and/or the discourse context (114).

(402) is the weight of a returned candidate (403). The weight may be stored as part of the candidate in some embodiments. (404) is an upper limit on any further candidates. The upper limit may be returned with each candidate (possibly as part of the candidate), or it may be available separately from the enumerator, e.g., by accessing a field or calling a method. (405) is a signal indicating that no more candidates are available from the semi-ordered enumerator; it causes the release gate (407) to release all candidates in the priority queue in descending order of weight.

(406) is a priority queue for buffering enumerated candidates (and their weights). From it, the highest weight candidate can be effectively returned. Any priority queue data structure known in the art can be used (e.g., a heap).

(407) is a release gate, allowing candidates to be removed from the priority queue and passed on to (410) for consumption. The consumer could be, e.g., a reference resolver, a joint disambiguator or a multi-context disambiguator, as described in the referenced patent applications. It could also be an ordered enumerator that combines several enumerators, as described below.

(408) is a comparator for comparing the upper limit and the best weight (411) in the priority queue. If the best weight is better (higher in the preferred embodiment) than the upper limit, it sends a signal (409) to the release gate (407) to release the highest weight candidate to the consumer. It keeps doing this until either the priority queue is empty or the best candidate there has a weight lower than the upper limit.

A different embodiment of converting a semi-ordered enumerator to an ordered enumerator using a priority queue is illustrated by the following pseudo-code (here, ‘enum’ is a semi-ordered enumerator, and output( ) forwards the output to further processing, pq.add( ) adds to priority queue, pq.get( ) returns the candidate with the highest weight and removes it from the queue( ) and pq.peek( ) returns the candidate with the highest weight without removing it):

PriorityQueue pq;
for (Candidate cand = enum.get_first_cand( ); cand;

cand = enum.get_next_cand( ))

{

pq.add(cand.weight( ), cand);
double upper_limit = enum.upper_limit( );
for (;;)

{

Candidate best_cand = pq.peek( );
double best_weight = best_cand.weight( );
if (best_weight < upper_limit)

break;

best_cand = pq.get( );
output(best_cand);

}

}

while (Candidate best_cand = pq.get( ))

output(best_cand);

In this pseudo-code, (401) corresponds to the first loop; (402,403) correspond to ‘cand’; (404) corresponds to ‘upper limit’; (405) corresponds to get first cand( ) or get next cand( ) returning NULL; (406) corresponds to ‘pq’; release gate (407) corresponds to the second loop and the final loop (there are two separate mechanisms implementing it as two separate cases); (408) corresponds to comparing ‘best weight’ and ‘upper weight’; (409) corresponds to the “break” statement causing outputting candidates to pause; (410) corresponds to whatever gets the candidate from ‘output( )’; and (411) corresponds to ‘best weight’.

The term reordering buffer refers to (406)-(409) and (411) in the figure.

Filtering could also be implemented within the reordering buffer, and in fact could advantageously be performed before reordering the candidates (thus reducing the size of the priority queue). A reordering buffer or the corresponding method steps may be inserted after filtering in embodiments that filter using soft filtering in places where descending order need to be retained.

An important difference to priority-queue based sorting is that the candidates are released as soon as the upper limit indicates there cannot be any better candidates coming later. This is important, as one of the objectives was to avoid having to enumerate all potential candidates from enumerators that may generate very many of them.

### Direct Implementation of Ordered Discourse Referent Enumerator

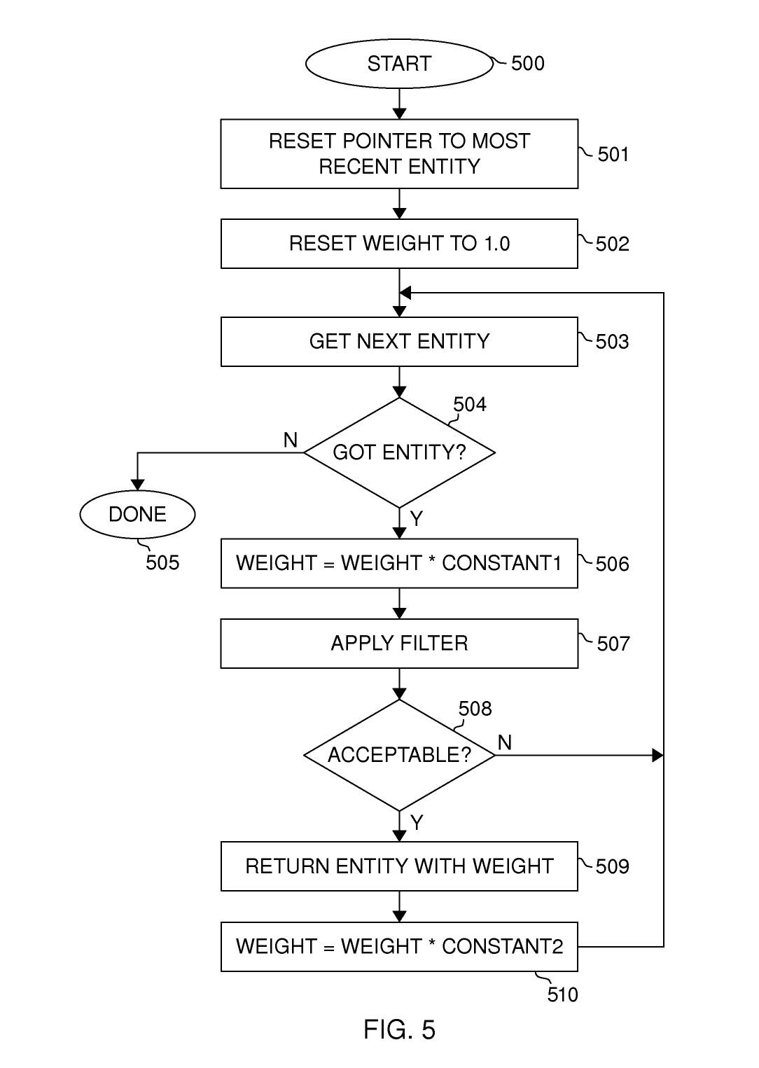

FIG. 5 illustrates a possible implementation of an ordered discourse enumerator directly. A discourse enumerator enumerates candidate referents that have been previously mentioned in the current discourse (or document), though such referents need not necessarily have been using the same words.

Here it is assumed that as text is parsed, any previously mentioned entities (objects, people, actions, etc.) are saved in an array, list, or other suitable data structure within the discourse context. They could also be stored at least partially in a parse context, as the sequence may be different in different parse contexts. The information might then be moved from the parse context to the discourse context when the system commits to a particular parse. In a practical embodiment only some number, such as 30, of the most recently referenced entities are retained. A ring buffer could be advantageously used to store them.

The enumeration process starts at (500). At (501), a pointer is set to point to the most recently mentioned entity. At (502), the weight (upper limit) is set to 1.0.

At (503), the entity pointed to by the pointer is retrieved, and the pointer is advanced to the next older entity. At (504), it is checked if there was an entity still available, and if not, enumerating terminates at (505).

At (506), the weight (upper limit) is updated. In this example, it is multiplied by a constant (e.g., 0.95), thus resulting in exponential decrease of weight. The update could also depend on other factors, such as the number of seconds since the entity occurred in an interactive discourse. Other formulas could also be used; for example, if a fixed number of entities is kept, the weight could be decreased linearly (e.g., weight=1.0−idx/N). The update here illustrates decay of weight by distance.

Any applicable filter is applied at (507). This may use gender, adjectives, relative clauses, prepositional phrases, etc., to limit which entities are acceptable (absolute filtering) or adjust the weight of the candidate based on how well the entity matches the constraints. At (508), if the filter did not accept the entity, control returns to (503) to get the next candidate. If the weight was adjusted a reordering buffer may be used to put the candidates back into descending order by weight.

At (509) the entity (or a separate candidate data structure constructed from it) is passed onwards to whatever consumes it. A weight is passed along with the candidate. The weight of the candidate may be the one computed at (506), possibly adjusted by filtering. It may also be partially computed from other salience factors, such as whether the entity occurred in subject or object position, topicality, emphasis, etc.

At (510), the weight (upper limit) is adjusted by multiplying it by a second constant (e.g., 0.5). This constant represents the shadowing effect of a later matching constituent.

Some embodiments might also include a penalty for matching “too early” to reduce the weight of candidates that are unlikely to be correct referents because a different expression (e.g., a personal pronoun or zero) would normally have been used for such a referent.

Combining Enumerators with Dynamic Weight Adjusting

Combining several ordered enumerators into a single ordered enumerator can be very useful in dealing with ambiguity relating to the interpretation of determiners (or more generally, to ambiguity relating to the type of the reference).

It is well known that “the” can be used to refer to, e.g., previously mentioned entities, associated (inferred) referents, shared knowledge between participants to the discussion, or generally known objects. It may also be used to indicate that the referred entity is somehow uniquely determined, even though not known. Furthermore, there are, e.g., many novels that begin by talking about the characters using definite articles as if they were known to the reader.

Likewise, even though “a” is usually thought to introduce a new entity, it can sometimes be used to refer to a mutually known entity, for example, by characterizing it enough so that it can only refer to a single person whom the speaker for some reason did not want to name. It may also have a generic meaning, referring to any member of a class. Sometimes the meaning of a sentence may resemble universal quantification over an entity introduced using “a”. Sometimes an indefinitely quantified noun phrase may mean “having characteristics of”, as in “she's a kitten” (of the million or so instances of “she's a kitten” found by Google, a small sample seems to indicate a double digit percentage referring to women).

A noun phrase without a determiner may equally mean a number of things. Likewise, a name may, e.g., refer to a known person, introduce a new person with that name, may mean the name literally (as in “Sara is a beautiful name”), or may refer to the characteristics of a well-known person (“He is very Rambo”—“very Rambo” alone gives over 6000 hits in a Google search as of this writing).

Analyzing the various determiners and semi-determiners reveals that very many of them are somehow ambiguous with regard to where the referent may be found, what is the epistemic type of the referent (e.g., individual, set, class), or how it should be quantified in a logical sense.

Conventionally, the different interpretations that are possible for referring expressions have been ignored, and most computational reference resolution systems simply select one interpretation before even trying to resolve references and fit them into the overall context.

Combining referents from several enumeration methods (e.g., for different interpretations of determiners) could therefore be very useful for implementing robust natural language understanding systems. It is difficult to implement an ordered enumerator for such multiple interpretations directly, as no upper bound can easily be set for all of the enumeration sources simultaneously. Furthermore, different determiners may imply different weights or likelihoods for the different interpretations, and the weights may even vary based on the speaker, dialect, genre of the text, etc.

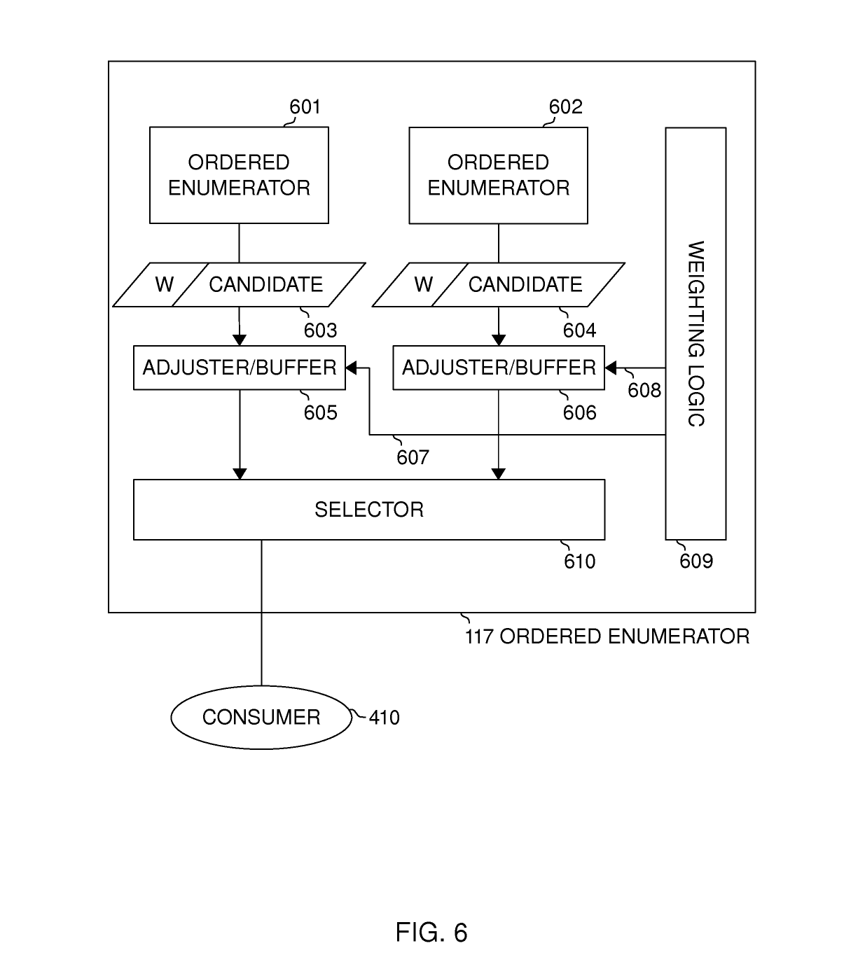

FIG. 6 illustrates constructing an ordered enumerator (117) by combining two or more simpler ordered enumerators and dynamically adjusting their weights. (601) and (602) illustrate ordered enumerators being combined. (603) and (604) illustrate candidates output by these enumerators, respectively (each candidate comprising a weight).

(605) and (606) illustrate adjuster/buffer circuits. The function of these elements is to adjust the weight of the candidates as configured by the weighting logic (609). The weighting logic determines a relative weighting for the enumerators, and assigns a multiplier (607,608) to each adjuster/buffer. The adjuster/buffer multiplies the weight of the candidate by this value (the value is preferably in the range 0 to 1.0). Furthermore, the adjuster/buffer keeps one or more candidates with the adjusted weight in store, until the selector (610) is ready to accept them. Typically some form of flow control would be used between the enumerators and their corresponding adjuster/buffers, to avoid unlimited growth of the buffer (the buffer could, e.g., request the next candidate from the enumerator when the buffer is empty).

The weighting logic (609) configures the adjuster/buffers. It determines, based on the referring expression and the context, the weights to assign to the adjuster/buffers. The weights are typically determined based on how likely each interpretation of a determiner is (or more generally, how likely the kind of referent represented by each enumerator is).

In some embodiments, the enumerators to use and their relative weights may be configured in the lexicon for each determiner (or in the grammar for certain other constructs, such as noun phrases without a determiner).

The selector (610) compares the weights of the candidates available from each of the adjuster/buffers, and selects the adjuster/buffer that has the highest weight candidate. It then gets the candidate from the adjuster/buffer, and passes it on to the consumer (410). The adjuster/buffer may then get the next candidate from the corresponding ordered enumerator. The selector waits until all adjuster/buffers have a candidate, or are empty and have indicated that they will not be receiving any more candidates from their respective enumerators. The number of candidates to be taken from each enumerator may also be limited to a suitable maximum number, or to within a threshold of the best candidate from that enumerator.

The adjustment method for the weights comprises at least one parameter and a method of adjusting the weight of candidates using the parameter(s). Selecting an adjustment method may mean selecting the parameter (e.g., weight multiplier) and/or selecting the way of computing the new weight.

In some embodiments at least one of the ordered enumerators may be a semi-ordered enumerator, and a reordering buffer is used (typically within the adjuster/buffer) to reorder the candidates into non-monotonically descending order. In some other embodiments the weight adjustment method may change the weights in a manner that causes previosly ordered candidates to not be in the desired order. In such a case, a reordering buffer or comparable functionality may be included in the adjuster/buffer to restore non-monotonically descending order of the candidates.

In many embodiments, if enumeration of from the combined enumerator is cut off, the enumerations from each of the enumerators from which it read candidates are cut off.

### Miscellaneous

In some embodiments, enumeration results may also be cached. Such caching could be keyed by both the referring expression and various aspects of the context.

Many variations of the above described embodiments will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

A pointer should be interpreted to mean any reference to an object, such as a memory address, an index into an array, a key into a (possibly weak) hash table containing objects, a global unique identifier, delegate, or some other object identifier that can be used to retrieve and/or gain access to the referenced object. In some embodiments pointers may also refer to fields of a larger object.

A computer may be any general or special purpose computer, workstation, server, laptop, handheld device, smartphone, wearable computer, embedded computer, a system of computers (e.g., a computer cluster, possibly comprising many racks of computing nodes), distributed computer, computerized control system, processor, or other similar apparatus whose primary function is data processing.

A computer program product according to the invention may be, e.g., an on-line help system, an operating system, a word processing system, an automated/semi-automated customer support system, or a game.

Computer-readable media can include, e.g., computer-readable magnetic data storage media (e.g., floppies, disk drives, tapes, bubble memories), computer-readable optical data storage media (disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be read by a computer.

What is claimed is:

1. A method comprising:
enumerating, by a computer, a first plurality of candidate referents for a referring expression in a natural language expression in semi-descending order of weight using a first enumeration source; and
cutting off, by the computer, the enumeration before all available candidates have been enumerated in response to set criteria for previously enumerated candidates having been met.

2. The method of claim 1, wherein the semi-descending order is an order where there is a non-monotonically descending upper limit on the weight of any later enumerated candidates.

3. The method of claim 2, further comprising:
buffering a plurality of the enumerated candidates; and
releasing candidates from the buffer in non-monotonically descending order.

4. The method of claim 3, wherein at least one of the candidates is released from the buffer in response to its weight exceeding the upper limit before all candidates have been enumerated.

5. The method of claim 2, wherein the weight of a candidate indicates the upper limit of the weight of any further candidates that may be returned by the enumerator.

6. The method of claim 5, wherein the upper limit is communicated separately from the candidate when enumerating.

7. The method of claim 1, wherein the set criteria include that the weight of any further candidates cannot become within a threshold of the best already enumerated candidate.

8. The method of claim 1, wherein the set criteria include that the desired number of candidates has already been enumerated, and the weight of any further candidates cannot become better than the weight of the worst candidate in the already enumerated candidates.

9. The method of claim 1, further comprising:
enumerating, by the computer, a second plurality of weighted candidate referents for the same referring expression in semi-descending order of weight using a second enumeration source;
selecting a weight adjustment method for each of the sources;
adjusting the weight of the returned candidates according to the selected adjustment method for each source, wherein the adjustment method causes the weight of at least one candidate from at least one source to be modified; and
selecting the next returned candidate to be the best weighted candidate from either of the sources.

10. The method of claim 9, wherein each order is a non-monotonically descending order.

11. The method of claim 9, wherein the candidates from at least source are reordered into non-monotonically descending order after adjusting their weight.

12. The method of claim 9, wherein the adjustment method is multiplication by a constant.

13. The method of claim 12, wherein a determiner in the referring expression influences the selection of the sources to use and the selection of the adjustment method for each source.

14. The method of claim 9, wherein the selection of the adjustment method is influenced by the discourse context in which the referring expression occurs.

15. The method of claim 1, wherein the semi-descending order is a non-monotonically descending order.

16. The method of claim 1, further comprising filtering candidates based on constraints derived at least in part from the referring expression.

17. The method of claim 16, further comprising annotating the filtered candidates with information about how the constraints were used.

18. The method of claim 16, wherein the filtering is performed before computing the weight for a candidate.

19. The method of claim 16, further comprising filtering of the candidates, wherein at least one constraint used in the filtering is not absolute, and the weight of at least one filtered candidate is adjusted in response to a failure to match the constraint.

20. An apparatus comprising:
a natural language interface comprising a reference resolver;
a first semi-ordered enumerator coupled to the reference resolver; and
a cutoff logic coupled to the enumerator for terminating enumeration before all available candidates have been enumerated in response to set criteria for previously enumerated candidates having been met.

21. The apparatus of claim 20, wherein the enumerator is an ordered enumerator.

22. The apparatus of claim 20, further comprising a reordering buffer coupled between the semi-ordered enumerator and the cutoff logic.

23. The apparatus of claim 20, further comprising:
a second semi-ordered enumerator;
a first adjuster/buffer connected to the first semi-ordered enumerator;
a second adjuster/buffer connected to the second semi-ordered enumerator;
a weighting logic for selecting weight adjustment methods for the adjuster/buffers; and
a selector for selecting the candidate with the highest weight after weight adjustment.

24. The apparatus of claim 20, further comprising a filter embedded within the semi-ordered enumerator for determining whether each potential candidate matches constraints imposed on the referent.

25. The apparatus of claim 20, wherein the apparatus is a computer.

26. The apparatus of claim 20, wherein the apparatus is a robot.

27. The apparatus of claim 20, wherein the apparatus is a home appliance.

28. The apparatus of claim 20, wherein the apparatus is an office appliance.

29. A computer comprising:
a means for resolving references in a natural language expression;
a means, coupled to the means for resolving references, for enumerating candidates for a referring expression in a natural language expression in descending order of weight;
a means, coupled to the means for enumerating, for cutting off the enumeration before all available candidates have been enumerated in response to set criteria for previously enumerated candidates having been met.

30. The computer of claim 29, further comprising a means, coupled to the means for enumerating, for reordering candidates returned by the means for enumerating into non-monotonically descending order by their weight.

31. The computer of claim 29, further comprising:
a second means for enumerating candidates for the same referring expression in descending order of weight;
for each means for enumerating, a means coupled to the means for enumerating for adjusting the weight of enumerated candidates according to a relative weight associated with the respective means for enumerating;
a means, coupled to each of the means for adjusting, for selecting the candidate with the best weight after adjusting to be returned next.

32. A computer program product stored on a tangible computer-readable medium, operable to cause a computer to resolve references for a referring expression in a natural language expression, the product comprising:
a computer readable program code means for enumerating a first plurality of weighted candidate referents for the referring expression in semi-descending order; and
a computer readable program code means for cutting off the enumeration before all available candidates have been enumerated in response to set criteria for previously enumerated candidates having been met.

33. The computer program product of claim 32, wherein the semi-descending order is a non-monotonically descending order.

34. The computer program product of claim 32, further comprising:
a computer readable program code means for reordering candidates obtained from the means for enumerating into non-monotonically descending order by their weight.

35. The computer program product of claim 32, wherein the means for enumerating comprises a means for combining enumerators with dynamic weight adjusting.
